(19) United States
(12) Patent Application Publication
(10) Pub. No.: US 2013/0037170 A1
(43) Pub. Date: Feb. 14, 2013

(54) Individual Feed Chain Tension System for Tree Chipper

(71) Applicants: James L. O'Halloran, Pella, IA (US); Stephen Daining, Pella, IA (US)

(72) Inventors: James L. O'Halloran, Pella, IA (US); Stephen Daining, Pella, IA (US)

(21) Appl. No.: 13/206,245

(22) Filed: Aug. 9, 2011

(51) Int. Cl. B65G 23/44; B27M 1/00; B27B 31/00

(52) U.S. Cl. 144/242.1

(57) ABSTRACT

A log and/or tree chipper has an individual feed chain tension system for multiple chains. A mechanism is provided for quick and easy independent adjustment for differences in chain length. Therefore, if a tail pulley is damaged, one section can be repaired while not requiring all of the drag chains to be split and the whole tail pulley removed. To keep the adjustment from moving out of adjustment after the adjusting step, a push bolt lock slips over adjusting bolts and the push bolt lock can be held in place with lynch pins.

### CROSS REFERENCE TO RELATED APPLICATIONS

Not applicable.

### BACKGROUND OF THE INVENTION

1. Field of the Invention

This invention relates to feed control for a log and/or tree chipper. More particularly, the invention relates to a method and apparatus for providing an individual feed chain tension system for a log/tree chipper.

2. Background Art

Typical whole tree chipper conveyors use multiple strands of drag chains. The drag chain is running in chips, mud and dirt continually while the machine is running. This combination causes the chain, sprocket and floor to wear. The chain also suffers abuse from the logs being dropped and from loaders. Eventually the chain will fail and will need to be replaced. Machines in the prior art use a head pulley that has multiple sprockets attached on a common shaft that drive all of the drag chains together. The tail pulley is a common shaft with multiple sprockets that return all of the drag chains together. The common way to set the tension on the feed conveyor is by sliding the tail pulley away from the head pulley. This works satisfactorily when the chains are new and relatively the same length, but if one chain fails a new chain replacement chain will usually be substantially shorter than the old chain(s) still on the machine. Consequently, in such prior art system, if the tension on one of the chains is adjusted to an optimum amount, the other chain will not be tensioned at an optimum amount. Setting the tension correctly for the new chain will let the old chains slip and setting the tension correctly for the old chain will cause extra wear and damage to the new chain. Compromising by setting the tension between the best setting of tension between what is best for the old and new chain means that both chains will not work in an optimum fashion.

There is, therefore, a need for a method and apparatus to allow for individual chain tension adjustment to match the different drag chain physical conditions.

### BRIEF SUMMARY OF THE INVENTION

The present invention allows for quick and easy independent adjustment for differences in chain length. Therefore, if a tail pulley is damaged, one section can be repaired while not requiring all of the drag chains to be split and the whole tail pulley to be removed. To keep the adjustment from moving out of adjustment after the adjusting step, a push bolt lock slips over adjusting bolts and the push bolt lock can be held in place with lynch pins.

### BRIEF DESCRIPTION OF THE DRAWINGS

FIG. 1 is a perspective view of a whole tree chipper constructed in accordance to the present invention with a feed table having two drag chains for moving logs/trees to a feed roller;

FIG. 2 is an enlarged perspective view of the chipper of FIG. 1 with a portion of the feed table removed to show an feed chain trained around a powered drive sprocket and an idler sprocket and showing parts of an independent idler sprocket adjusting mechanism;

FIG. 3 is a side view of the feed table of FIG. 2 taken along line 3-3 of FIG. 2;

FIG. 4 is an enlarged perspective view of the two feed chains trained around respective powered drive sprockets in the front and idler sprockets in the back and showing the independent adjustment mechanism for the idler sprockets;

FIG. 5 is an enlarged perspective view of the rear idler sprockets and the independent adjusting mechanisms associated therewith;

FIG. 6 is a partial top view of the rear of the feed table with the feed chain removed to show the rear idler sprockets when the axes of rotation of both rear sprockets are in alignment, for example when the machine is originally manufactured;

FIG. 7 is a partial top view of the rear of the feed table, like FIG. 6, but with the feed chain removed to show the rear idler sprockets when the axes of rotation of both rear sprockets are not aligned, for example when the left one of the feed chains has been replaced with a new feed chain and the other (right) feed chain has been in operation for a considerable time and (for example) because of wear is longer than a new feed chain;

FIG. 8 is a cross sectional view of the idler sprockets with the adjusting mechanism of the present invention shown.

FIG. 9 is a view taken along line 9/10-9/10 of FIG. 8 showing a pair of adjusting threaded members that, when rotated in one direction, move the idler sprockets back and when rotated in an opposite direction move the idler sprockets forwardly towards the feed roller, a wrench engaging end of each of the adjusting threaded members having a locking bar with slots that prevents the pair of adjusting members from rotating when the locking bar is in the position shown in FIG. 9;

FIG. 10 is a view taken along line 9/10-9/10 of FIG. 8 showing the pair of adjusting threaded members with the locking wrench removed from the locking slots of the adjusting threaded members and a wrench opening in the locking wrench engaging the front end of the right adjusting threaded member, thereby showing that the locking wrench can be used to rotate and thereby adjust the forward/rear position of each individual idler sprocket by rotating the adjusting members;

FIG. 11 is an enlarged perspective view looking under the feed table through an access opening to show parts of the independent idler sprocket adjusting mechanism, including the two threaded members with the locking wrench in place to prevent rotation of both threaded adjusting members and with lynch pins preventing the locking bar from slipping off of the threaded members;

FIG. 12 is an enlarged perspective view, similar to FIG. 11, looking under the feed table through an access opening to show parts of the independent idler sprocket adjusting mechanism, including the two threaded members with the locking wrench removed to allow rotation and thereby adjustment of either one or both of the locking members;

FIG. 13, an alternate embodiment, is an enlarged partial top view of only the idler sprockets on rear of a feed table but with the feed chain removed to show the rear idler sprockets when the axes of rotation of both rear sprockets are not aligned, for example when the left one of the feed chains has been replaced with a new feed chain and the other (right) feed chain has been in operation for a considerable time and (for example) because of wear is longer than a new feed chain;

FIG. 14 is a cross sectional view taken along line 14-14 of FIG. 13 to show elongated holes in the support members that the support shafts of each idler sprocket which can thereby be selectively moved and then tightened down to adjust the forward/rearward position of each idler sprocket independently;

FIG. 15 is a cross sectional view taken along line 15-15 of FIG. 13 to show slotted holes in the support members that the support shafts of each idler sprocket rotatably mounted therein, thereby allowing the idler sprockets to be selectively adjusted independently in a forward/rearward position by first loosening the then tightening the bolts 129; and

FIG. 16 is a cross sectional view taken along line 16-16 of FIG. 13 to show slotted holes in the support members that the support shafts of each idler sprocket are rotatably mounted in, thereby allowing the idler sprockets to be selectively adjusted independently in a forward/rearward position by first loosening, moving and then tightening threaded fasteners 128.

### DETAILED DESCRIPTION OF THE INVENTION

With reference now to the various figures in which identical elements are numbered identically throughout, a description of various exemplary aspects of the present invention will now be provided. The preferred embodiments are shown in the drawings and described with the understanding that the present disclosure is to be considered an exemplification of the invention and is not intended to limit the invention to the embodiments disclosed.

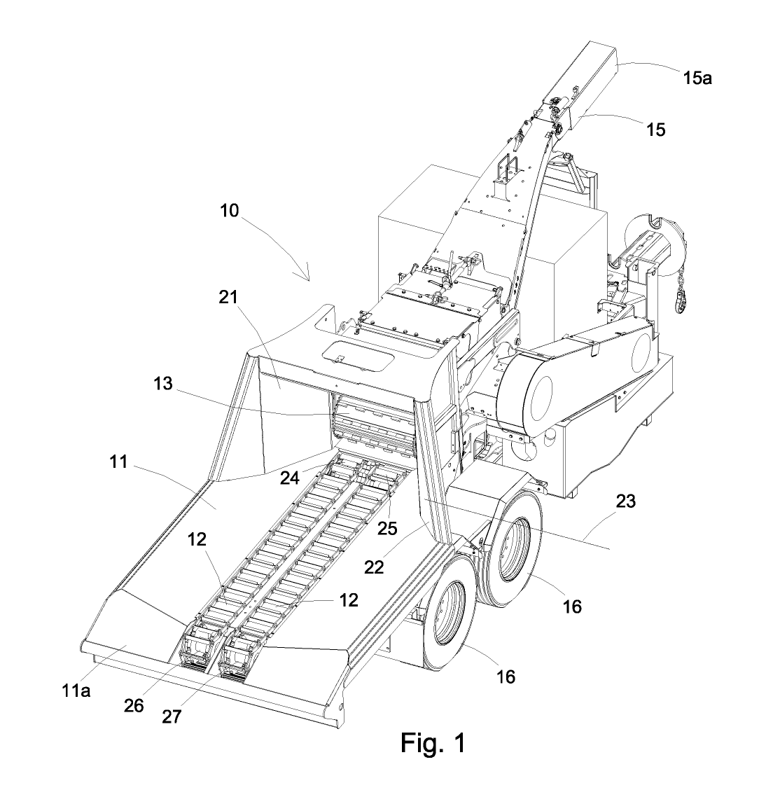

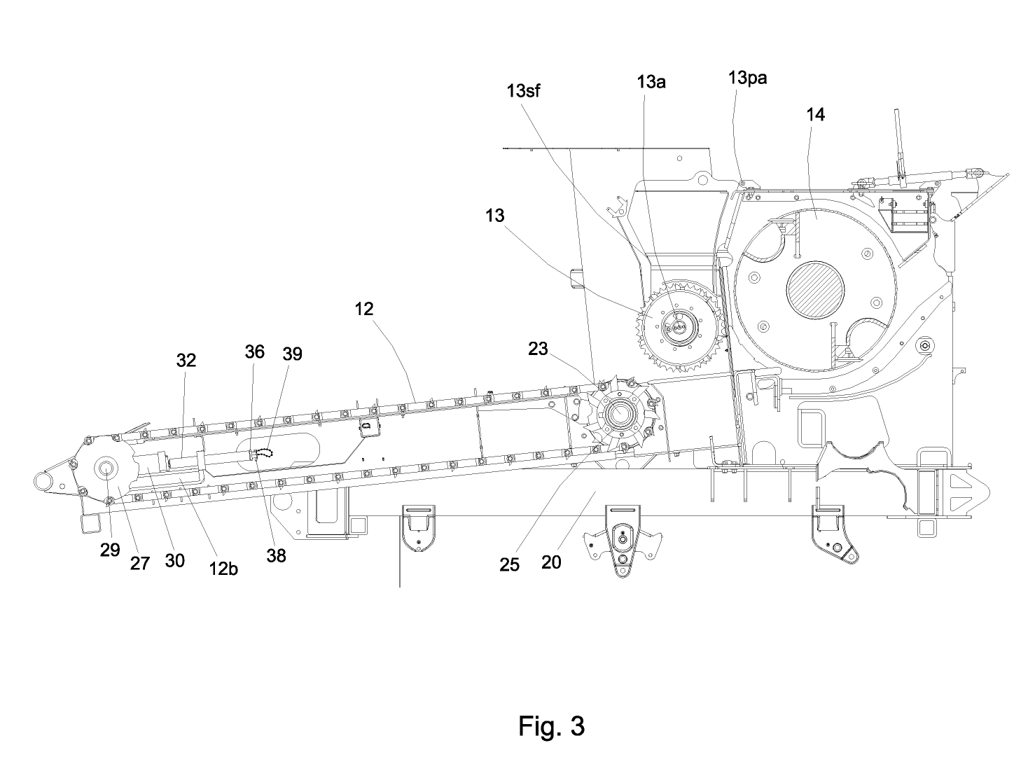

FIG. 1 shows log or whole tree chipper 10, with a feed table 11 having two feed chains 12 for moving trees or logs towards a feed roller 13. As in chippers in general, the feed roller 13 forces the logs or trees towards a chipping drum 14, as best shown in FIG. 3. The material reducing or chipping drum 14 cuts the wood into small chips and forces the small chips out a chute 15 as is typical of chippers of any size.

The brush chipper 10 is mounted on wheels 16 (FIG. 1), however, tracks and skids may also be used, and the brush chipper 10 may be stationary as well. The present invention is not limited to any particular conveyance apparatus, nor does it require the brush chipper 10 be portable.

Generally, the brush chipper 10 has a rear, feed end, 11a and a front, outfeed end, 15a. A feed direction is defined, for the purposes of this document, including the claims, as the direction the brush is forced while it is being chipped; that is, the feed direction is the direction going from the feed end 11a to the outfeed end 15a of the chipper 10.

The brush chipper machine 10 for processing logs and whole trees has a frame 20. The material reducing drum 14, shown best in FIG. 3, is operatively rotatably attached to the frame 20. The feed table 11 is bolted to the frame 20 for receiving and supporting trees and logs thereon, the feed table 11 having a top, a bottom, a front end and a rear end.

Looking to FIG. 3, the feed roller 13 is disposed between the feed table 11 and the material reducing drum 14 and is rotatably attached to a sub-frame 13sf about rotational axis 13a. The sub-frame 13sf is pivotally attached about pivotal axis 13pa so that the feed roller 13 can move up or down as logs/trees move there under towards the material reducing drum 14.

FIG. 1 shows a pair of mostly vertical walls 21 on each side of the feed roller 13, the walls 21 having a front and a rear and being farther apart at the rear thereof than at the front thereof for funneling logs and trees from the feed table 11 to the feed roller 13 and eventually to the material reducing drum 14.

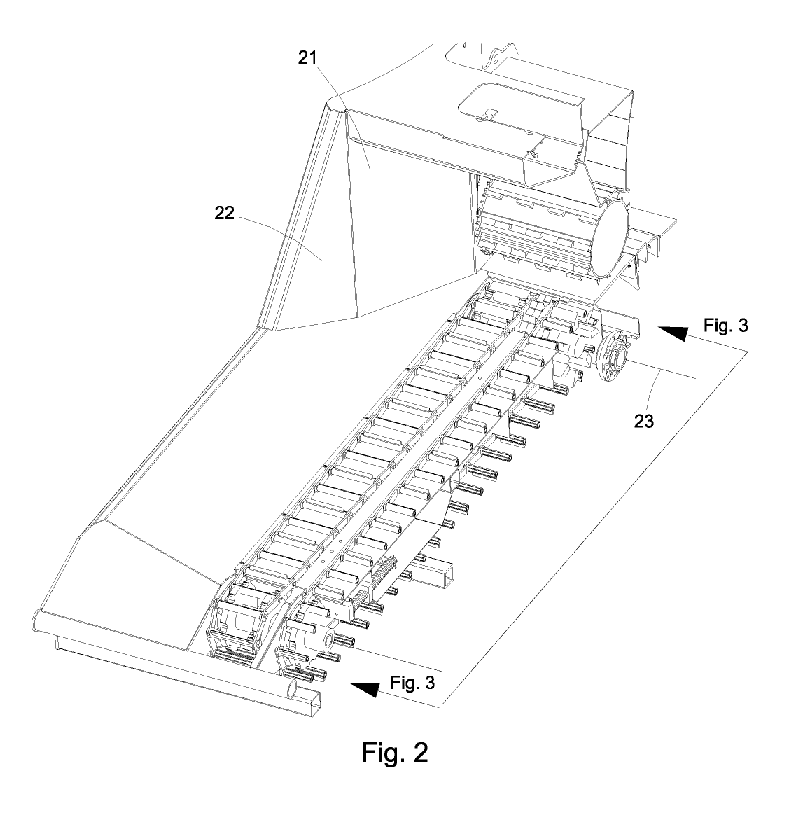

Looking to FIGS. 1 and 2, a first powered drive member, sprocket 24, (which could also be a pulley) is operatively rotatably attached to the frame along a first substantially a horizontal axis 23 located below the top, front end of the feed table 11. A second powered drive member, sprocket 25, (which could also be a pulley) is operatively rotatably attached to the frame along a second substantially horizontal axis located below the top, front end of the feed table 11, which second substantially horizontal axis can be coincident with the first substantially horizontal axis 23.

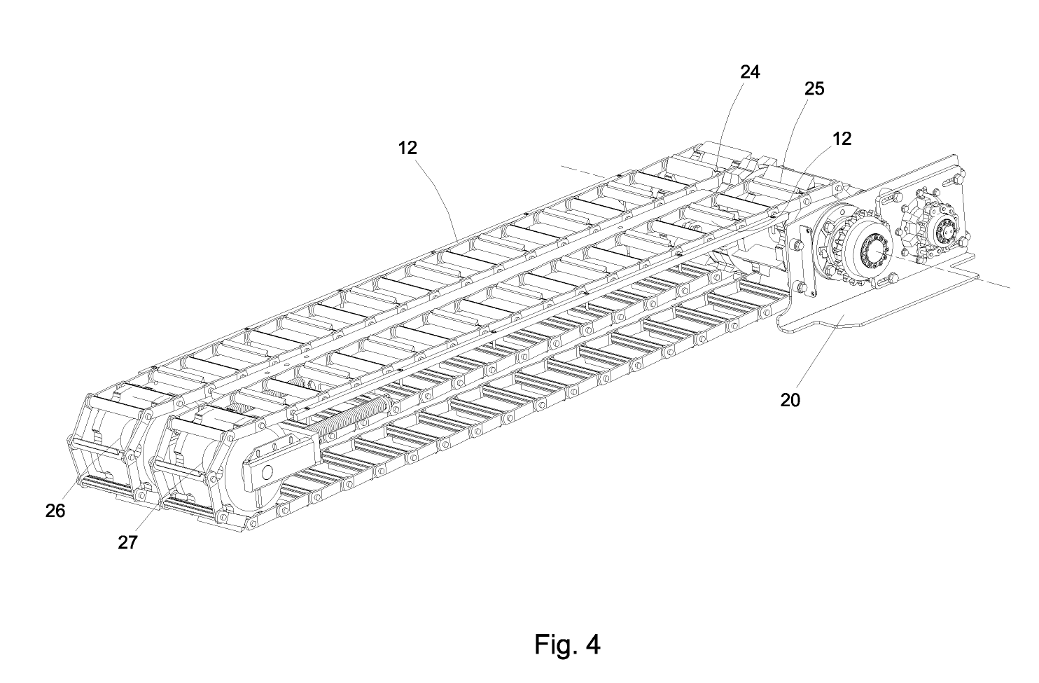

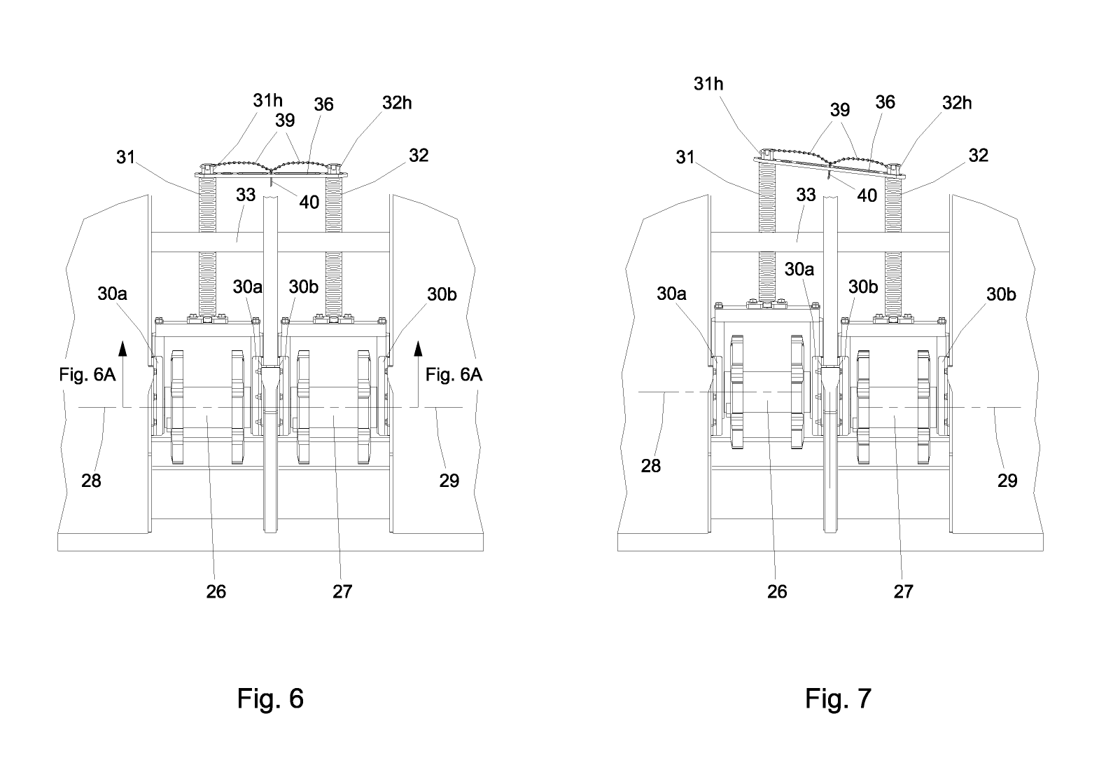

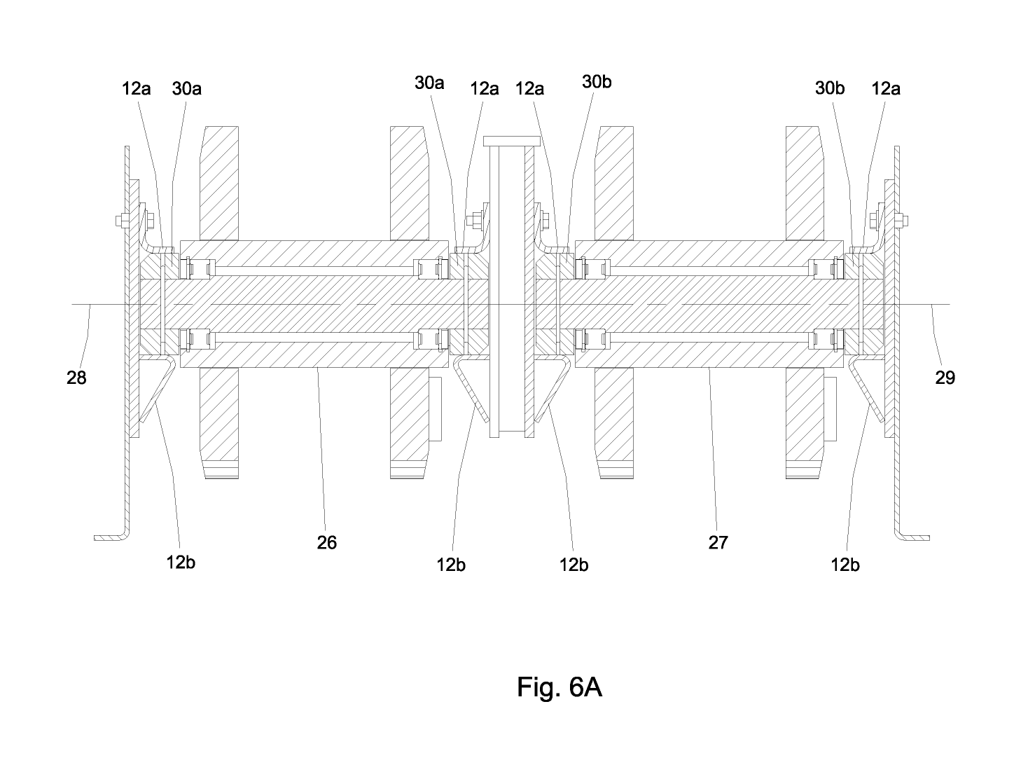

Looking now to FIGS. 1-6, a first idler member, sprocket 26 (which could also be a pulley type idler) is operatively rotatably attached to the frame along a third substantially horizontal axis 28 (FIG. 6) located below the top, rear end of the feed table 11. A second idler member 27 (sprocket or pulley) operatively rotatably attached to the the frame along a fourth substantially horizontal axis 29 (FIG. 6) located below the top, rear end of the feed table 11.

Looking now to FIGS. 1-4, there is a first feed conveyor chain 12, less than half the width of the feed roller 13, the first feed conveyor chain 12 being trained around the first powered drive member 24 and the first idler member 26 for selectively moving the logs and trees along the feed table 11 to the feed roller 13. A second feed conveyor chain 12 is also less than half the width of the feed roller 13, the second feed conveyor chain 12 being trained around the second powered drive member 25 and the second idler member 27 for selectively moving the logs and trees along the feed table 11 to feed table 13, the distance between the first substantially horizontal axis 23 and the third substantially horizontal axis 28 being a variable distance and the distance between the second substantially horizontal axis (which is also axis 23 in the embodiment shown) and the fourth substantially horizontal axis 29 being a variable distance as shown in FIGS. 6 and 7, for example.

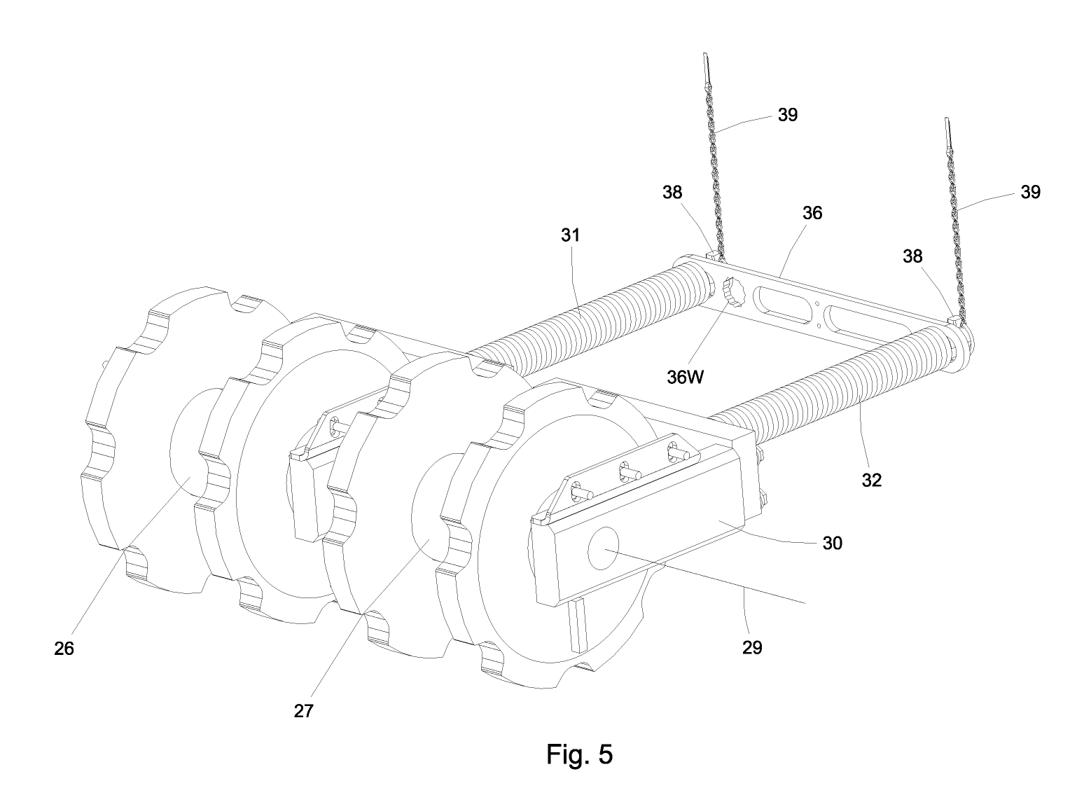

Looking to FIGS. 5-10 it is noted that carriage brackets 30 slide in slots 30s as shown in FIG. 6A. Idler sprockets 26 and 27 are rotatably mounted along axes 28 and 29 respectively and as carriage brackets 30 are adjusted forwardly or rearwardly in slots formed between frame members 12a and 12b as shown in FIG. 6A, the respective position of axes 28 and 29 changes.

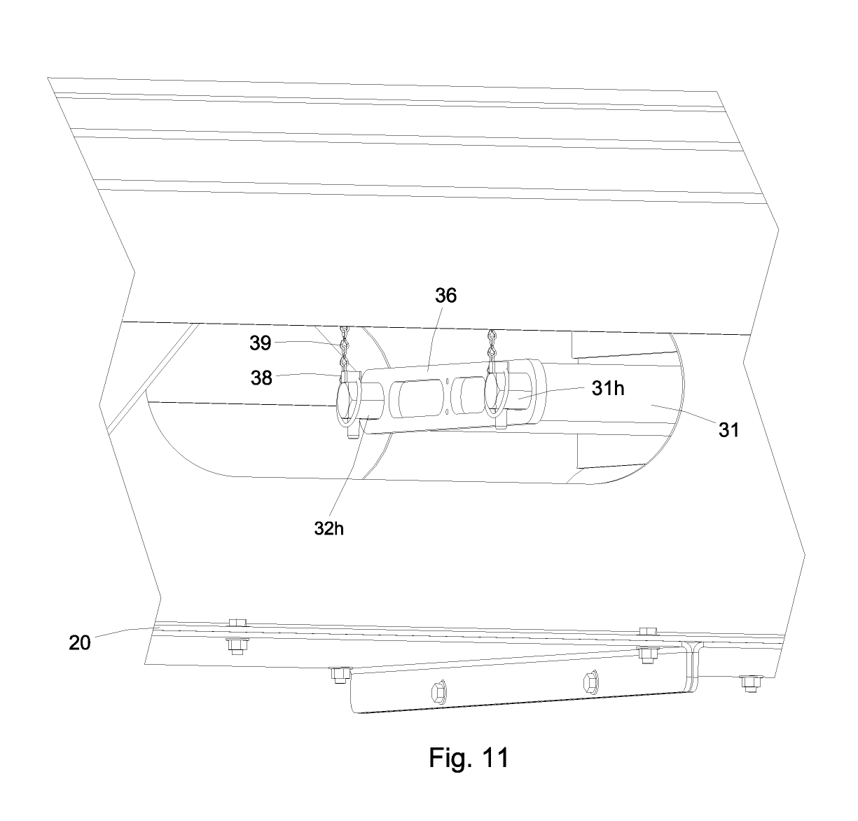

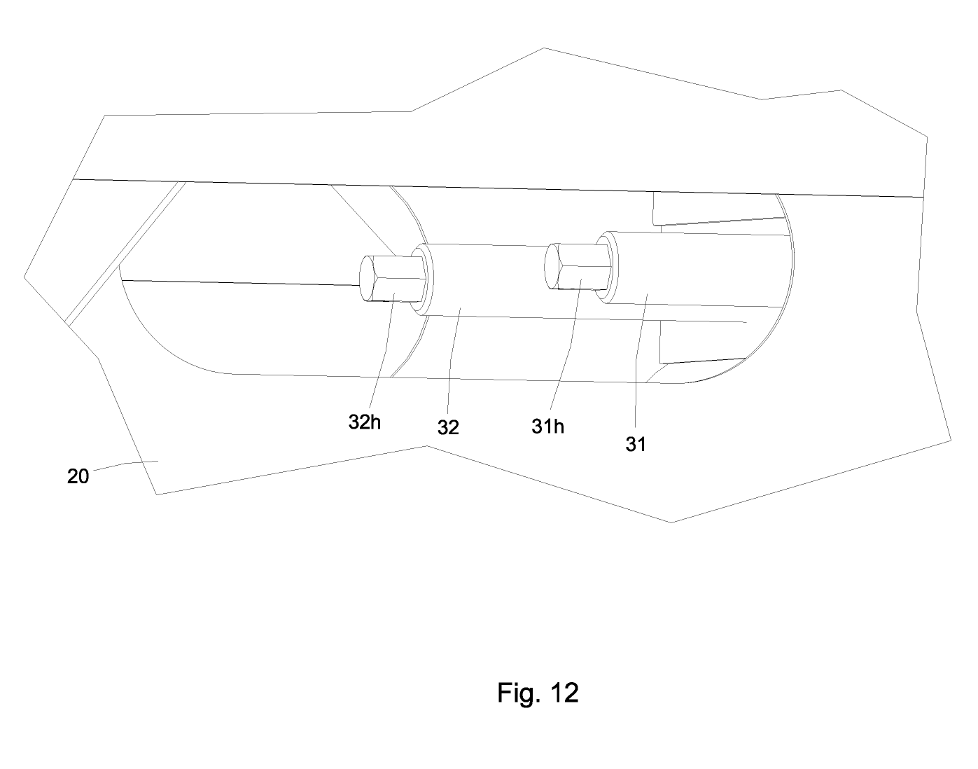

Looking now to FIGS. 6-12, the first adjusting member 31 is shown operatively attached to the frame 20 and to the first bracket 30 for selectively adjustably moving the first bracket 30a between first and second extreme positions thereof by rotating the first adjusting member 31 in one rotary direction through treaded bar 33. This will pull or push the first idler sprocket 26 forwardly or backwardly, by pulling or pushing on carriage brackets 30a/30b to cause them to slide in the slots formed between frame members 12a and 12b (FIG. 6A) in the frame 20. A second adjusting member 32 operatively attached to the frame 20 and to the second bracket 30b works just like first adjusting member 31 for selectively adjustably moving the second bracket 30b between the one position and another position thereof, for example as shown in FIGS. 6 and 7, whereby the first and second idler members 26 and 27 can be adjusted independently to accommodate first and second feed conveyor chains 12 of different lengths.

As indicated above, the first adjusting member 31 is a threaded member whereby turning the first threaded member 31 in a first rotary direction moves the first bracket forwardly towards the feed roller and turning the first threaded member in a second rotary direction moves the first bracket 30a away from the feed roller. The second adjusting member 32 is a second threaded member whereby turning the second threaded member 32 in a first rotary direction moves the second bracket forwardly towards the feed roller 13 and turning the second threaded member 32 in a second rotary direction moves the second bracket 30b away from the feed roller 13.

Looking to FIGS. 6-10, locking member 36 has a pair of slots 36a and 36b that are of a size and shape so that they fit over the hex ends 31h and 32h respectively of the forward ends of threaded members 31 and 32 respectively in the first locking position (FIGS. 6, 7 and 9) engaging both the first and second threaded members 31 and 32 for preventing the first and second threaded members from rotating with respect to each other, the locking member having a second non-locking position shown in FIG. 10. As mentioned above, the first and second threaded members each have at least one non-circular area (hex ends 31h and 32h) on the front end thereof and the locking member 36 is a bar with openings 36a and 36b therein, the non circular area of each of the first and second threaded members 31 and 32 extending through the openings 36a and 36b in the bar in the first position of the bar for preventing the first and second threaded members from rotating with respect to each other and when the bar is removed from the first locking position as shown in FIG. 10, to the second non-locking position thereof, either or both of the idler sprockets 26 and 27 can be adjusted.

The locking member 36 has an opening 36w therein sized to selectively fit over and engage the non circular area 31h and 32h of each of the first and second threaded members 31 and 32 whereby the locking member 36 can function as a wrench to independently selectively turn the first or second locking members 31 and 32, thereby ultimately independently adjusting the distance between the respective powered drive and idler members to as to accommodate first and second conveyor chains 12 of different lengths, for example as shown in FIG. 7.

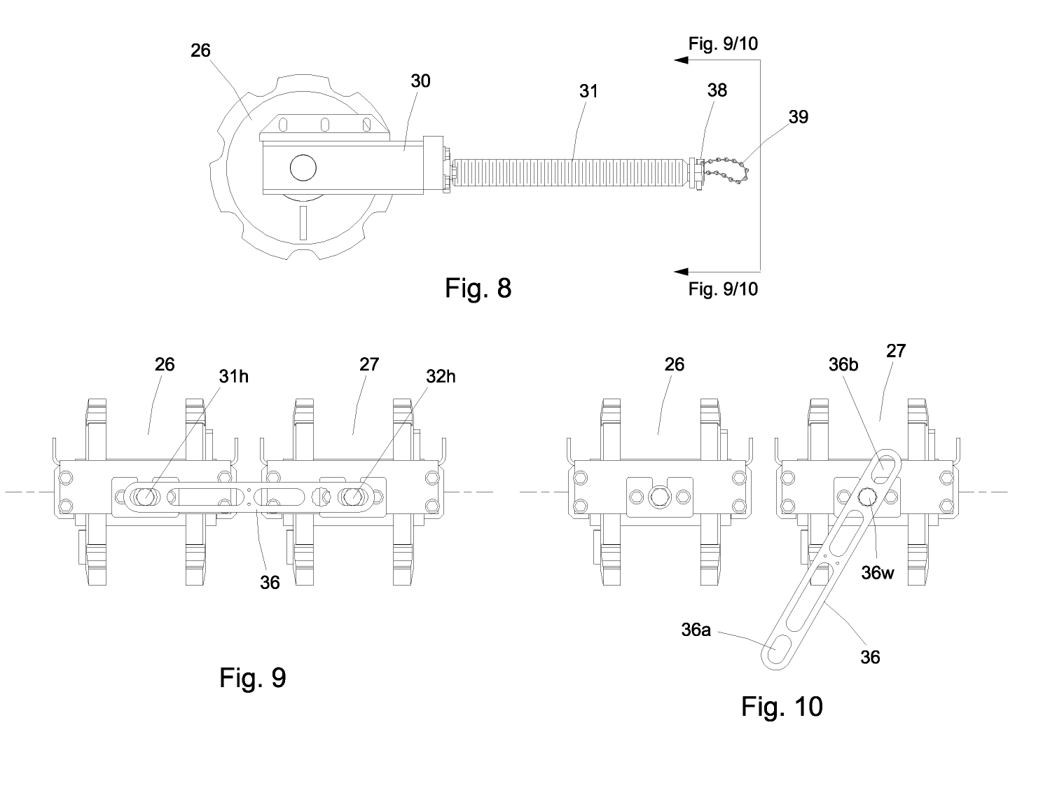

As can best be seen in FIG. 8, each of the first and second threaded members 31 and 32 have a hole in the hex ends 31h and 32h which holes are in front of the locking member when the locking member is in the first locking position thereof and a lynch pin 38 is disposed in each of the holes in the first and second threaded members for preventing the locking member 36 from moving from the first locking position, FIG. 6, 7 or 9 for example, thereof. Each lynch pin 38 is connected by a small chain 39 to a cotter key 40 extending through a hole in member 33 so as to keep from losing the lynch pins 38. (See FIG. 6.)

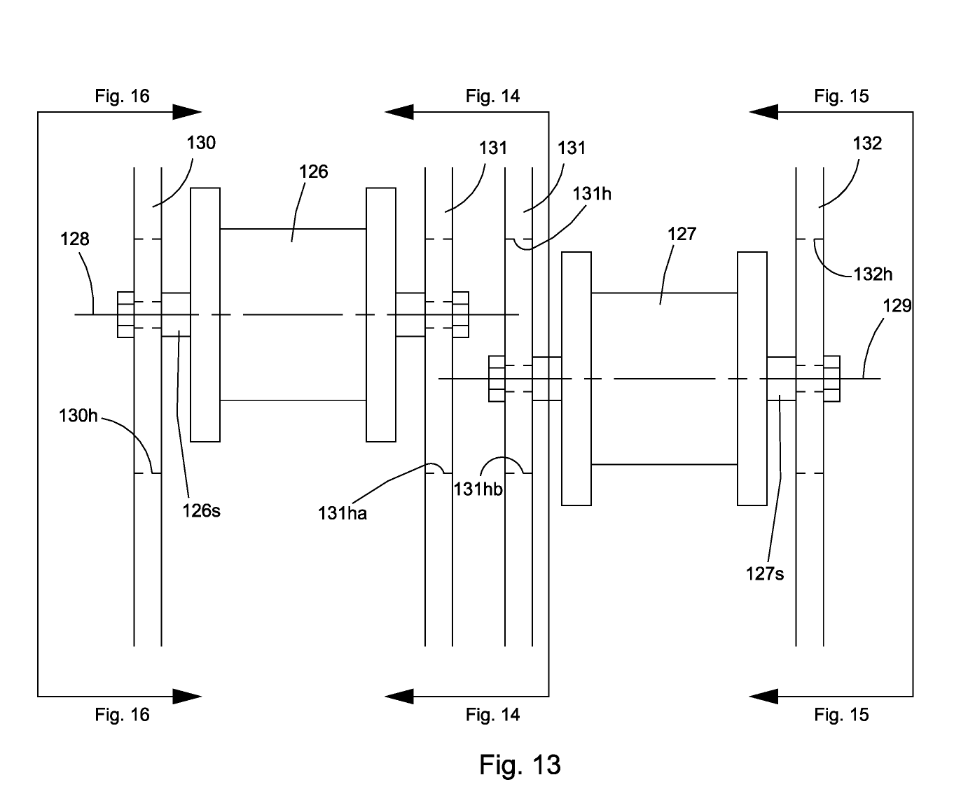

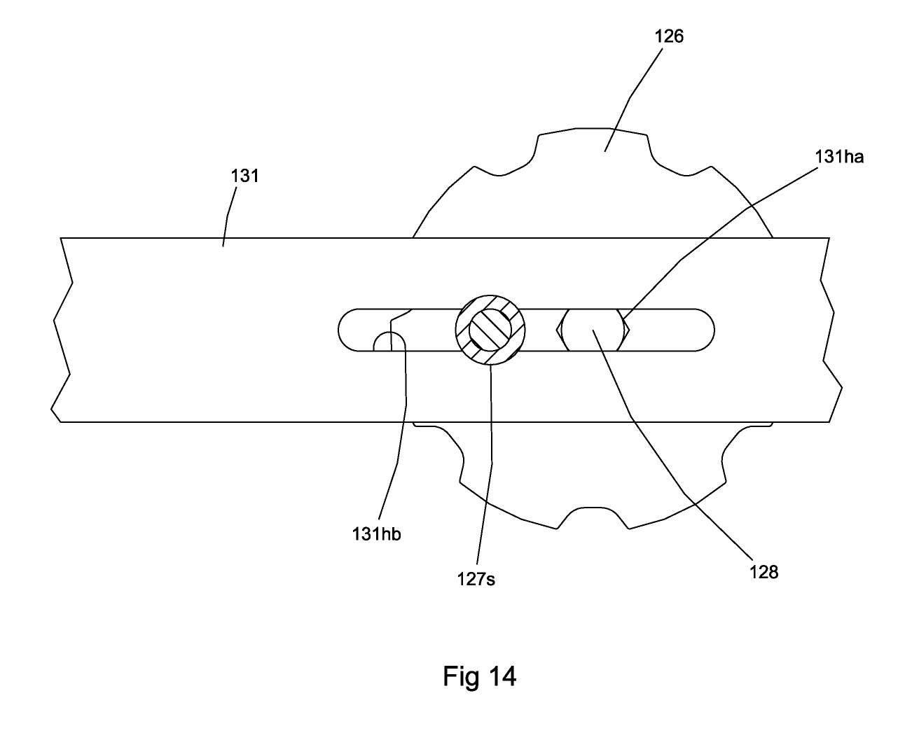

FIGS. 13-16 show an alternate embodiment and FIG. 13 is an enlarged partial top view of only the idler sprockets on rear of a feed table but with the feed chain removed to show the rear idler sprockets 126 and 127 when the axes of rotation 128 and 128 respectively of both rear sprockets 126 and 127 are not aligned, for example when the left one 126 of the feed chains (not shown) has been replaced with a new feed chain and the other (right) feed chain (not shown) has been in operation for a considerable time and, for example because of wear, is longer than the new feed chain. FIG. 14 is a cross sectional view taken along line 14-14 of FIG. 13 to show slotted holes in the support members that the support shafts of each idler sprocket 126 and 127 so that fasteners shown on the axes 128 and 129 can be loosened, the central shaft of respective sprocket 126 or 127 moved in the respective slotted holes and then tightened now again to thereby make the sprockets 126/127 selectively moveable to adjust the forward/rearward position of each idler sprocket 126 and 127 independently with respect to the front sprockets (not shown).

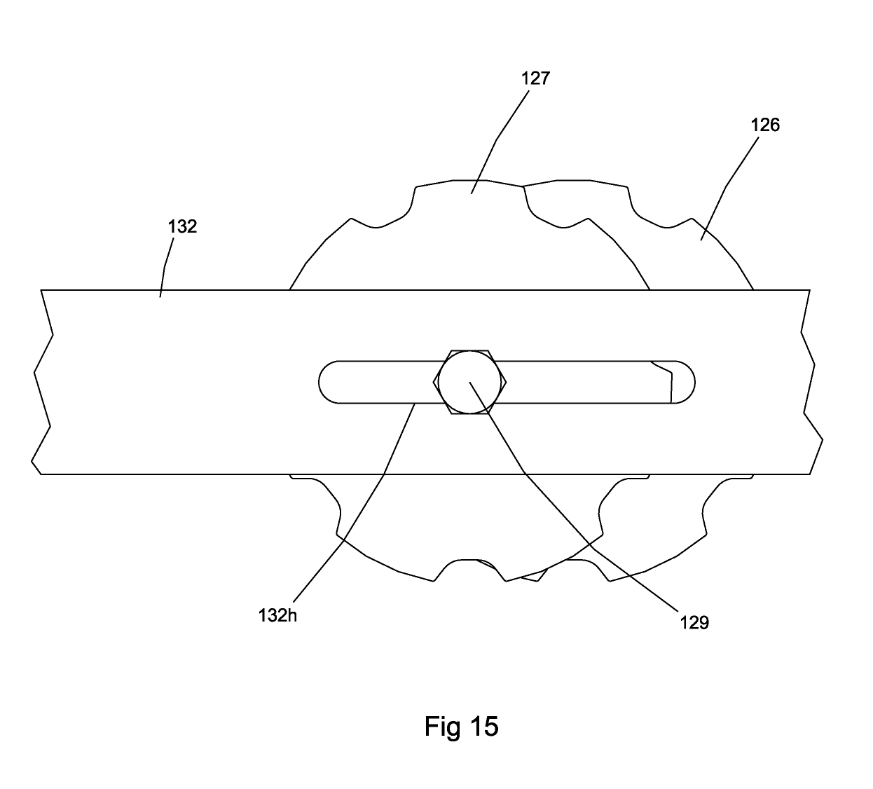

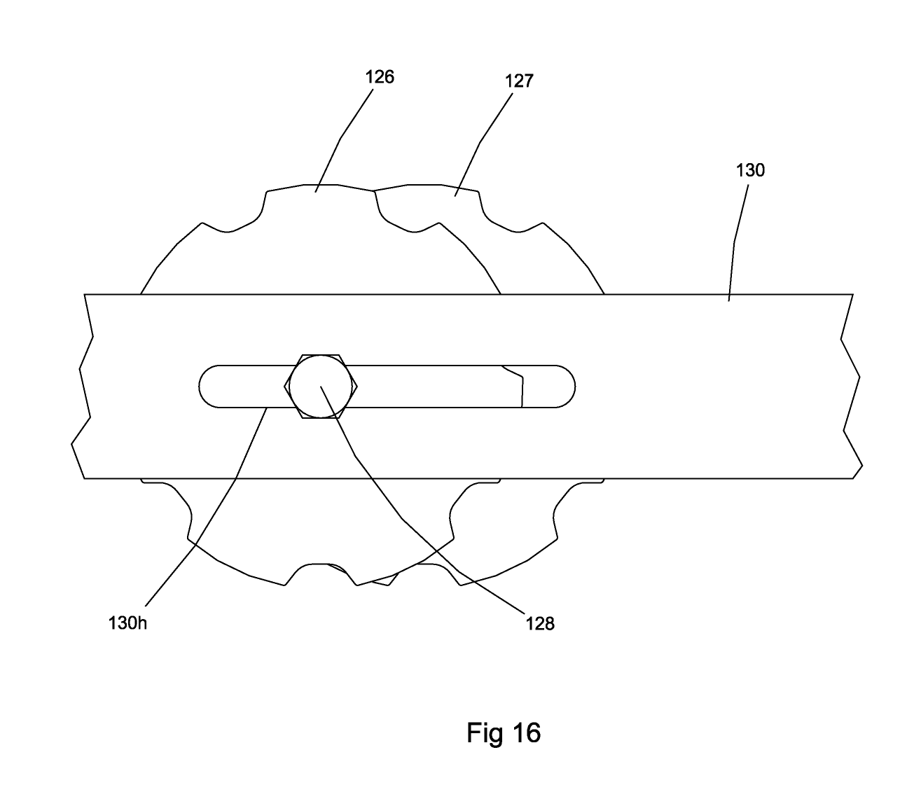

FIG. 15 is a cross sectional view taken along line 15-15 of FIG. 13 to show the slotted holes in the support members that the support shafts of each idler sprocket 126 and 127, thereby allowing the idler sprockets 126 and 127 to be selectively adjusted independently in a forward/rearward position. FIG. 16 is a cross sectional view taken along line 16-16 of FIG. 13 to show slotted holes in the support members that the support shafts of each idler sprocket 126 and 127 are rotatably mounted in, thereby allowing the idler sprockets 126 and 127 to be selectively adjusted independently in a forward/rearward position. Frame parts 130, 131 and 132 have a series of holes/slots 130h, 131ha, 131hb, 132h therein for reception of respective shafts 126a and 127a so that the sprockets 126 and 127 can be moved forwardly or rearwardly by adjusting the position of the shafts 126a and 127a in respective ones of the slotted holes 130h, 131ha, 131hb, 132h.

The above described embodiments are the preferred embodiments, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A machine for processing logs and whole trees comprising:
a frame;
a material reducing drum operatively attached to the frame;
a feed table operatively attached to the frame for receiving and supporting trees and logs thereon, the feed table having a top, a bottom, a front end and a rear end;
a feed roller rotatably disposed between the feed table and the material reducing drum, the feed roller having a width;
a pair of mostly vertical walls on each side of the feed table, the walls having a front and a rear and being farther apart at the rear thereof than at the front thereof for funneling logs and trees from the feed table to the feed roller;
a first powered drive member (sprocket or pulley) operatively rotatably attached to the frame along a first substantially horizontal axis located below the top, front end of the feed table;
a second powered drive member (sprocket or pulley) operatively rotatably attached to the frame along a second substantially horizontal axis located below the top, front end of the feed table, which second substantially horizontal axis can be coincident with the first substantially horizontal axis;
a first bracket operatively attached to the frame at the rear of the feed table, the first bracket being adjustably moveable between a first position closer to the first powered drive member and a second position farther from the first powered drive member;
a second bracket operatively attached to the frame at the rear of the feed table, the second bracket being adjustably moveable between one position closer to the first powered drive member and a another position farther from the first powered drive member;
a first idler member (sprocket or pulley) operatively rotatably attached to the first bracket along a third substantially horizontal axis located below the top, rear end of the feed table;
a second idler member (sprocket or pulley) operatively rotatably attached to the second bracket along a fourth substantially horizontal axis located below the top, rear end of the feed table;
a first feed conveyor chain less than half the width of the feed roller, the first feed conveyor chain being trained around the first powered drive member and the first idler member for selectively moving the logs and trees along the feed table to the feed roller;
a second feed conveyor chain less than half the width of the feed roller, the second feed conveyor chain being trained around the second powered drive member and the second idler member for selectively moving the logs and trees along the feed table to the feed roller;
a first adjusting member operatively attached to the frame and to the first bracket for selectively adjustably moving the first bracket between the first and second positions thereof; and
a second adjusting member operatively attached to the frame and to the second bracket for selectively adjustably moving the second bracket between the one position and another position thereof, whereby the first and second idler members can be adjusted independently to accommodate first and second feed conveyor chains of different lengths.

2. The machine of claim 1 wherein the first adjusting member is a first threaded member whereby turning the first threaded member in a first rotary direction moves the first bracket forwardly towards the feed roller and turning the first threaded member in a second rotary direction moves the first bracket away from the feed roller.

3. The machine of claim 2 wherein the second adjusting member is a second threaded member whereby turning the second threaded member in a first rotary direction moves the second bracket forwardly towards the feed roller and turning the second threaded member in a second rotary direction moves the second bracket away from the feed roller.

4. The machine of claim 3, further comprising a locking member having a first locking position engaging both the first and second threaded members for preventing the first and second threaded members from rotating with respect to each other, the locking member having a second non-locking position.

5. The machine of claim 4 wherein the first and second threaded members each have at least one non- circular area on the front end thereof and the locking member is a bar with openings therein, the non circular area of each of the first and second threaded members extending through the openings in the bar in the first position of the bar for preventing the first and second threaded members from rotating with respect to each other and when the bar is removed from the first locking position thereof to the second non-locking position thereof.

6. The machine of claim 5, wherein the locking member has an opening therein sized to selectively fit over and engage the non circular area of each of the first and second threaded members whereby the locking member can function as a wrench to independently selectively turn the first or second locking members, thereby ultimately independently adjusting the distance between the respective powered drive and idler members to as to accommodate first and second conveyor chains of different lengths.

7. The machine of claim 5, wherein each of the first and second threaded members have a hole therein which holes are in front of the locking member when the locking member is in the first locking position thereof and a pin is disposed in each of the holes in the first and second threaded members for preventing the locking member from moving from the first locking position thereof.

8. A machine for processing logs and whole trees comprising:
a frame;
a material reducing drum operatively attached to the frame;
a feed table operatively attached to the frame for receiving and supporting trees and logs thereon, the feed table having a top, a bottom, a front end and a rear end;
a feed roller rotatably disposed between the feed table and the material reducing drum, the feed roller having a width;
a pair of mostly vertical walls on each side of the feed roller, the walls having a front and a rear and being farther apart at the rear thereof than at the front thereof for funneling logs and trees from the feed table to the feed roller;
a first powered drive member (sprocket or pulley) operatively rotatably attached to the frame along a first substantially horizontal axis located below the top, front end of the feed table;
a second powered drive member (sprocket or pulley) operatively rotatably attached to the frame along a second substantially horizontal axis located below the top, front end of the feed table, which second substantially horizontal axis can be coincident with the first substantially horizontal axis;
a first idler member (sprocket or pulley) operatively rotatably attached to the frame along a third substantially horizontal axis located below the top, rear end of the feed table;
a second idler member (sprocket or pulley) operatively rotatably attached to the the frame along a fourth substantially horizontal axis located below the top, rear end of the feed roller;
a first feed conveyor chain less than half the width of the feed roller, the first feed conveyor chain being trained around the first powered drive member and the first idler member for selectively moving the logs and trees along the feed table to the feed roller;
a second feed conveyor chain less than half the width of the feed roller, the second feed conveyor chain being trained around the second powered drive member and the second idler member for selectively moving the logs and trees along the feed table to the feed roller;
the distance between the first substantially horizontal axis and the third substantially horizontal axis being a variable distance; and
the distance between the second substantially horizontal axis and the fourth substantially horizontal axis being a variable distance.

9. A machine for processing logs and whole trees comprising:
a frame;
a material reducing drum operatively attached to the frame;
a feed table operatively attached to the frame for receiving and supporting trees and logs thereon, the feed table having a top, a bottom, a front end and a rear end;
a feed roller rotatably disposed between the feed table and the material reducing drum, the feed roller having a width;
a pair of mostly vertical walls on each side of the feed roller, the walls having a front and a rear and being farther apart at the rear thereof than at the front thereof for funneling logs and trees from the feed table to the feed roller;
a first powered drive member (sprocket or pulley) operatively rotatably attached to the frame along a first substantially horizontal axis located below the top, front end of the feed table;
a second powered drive member (sprocket or pulley) operatively rotatably attached to the frame along a second substantially horizontal axis located below the top, front end of the feed table, which second substantially horizontal axis can be coincident with the first substantially horizontal axis;
a first idler member (sprocket or pulley) operatively rotatably attached to the first bracket along a third substantially horizontal axis located below the top, rear end of the feed table, the first idler member being adjustably moveable between a first position closer to the first powered drive member and a second position farther from the first powered drive member;
a second idler member (sprocket or pulley) operatively rotatably attached to the second bracket along a fourth substantially horizontal axis located below the top, rear end of the feed table, the second idler member being adjustably moveable between one position closer to the first powered drive member and another position farther from the first powered drive member, whereby the first and second idler members can be adjusted independently to accommodate first and second feed conveyor chains of different lengths;
a first feed conveyor chain less than half the width of the feed roller, the first feed conveyor chain being trained around the first powered drive member and the first idler member for selectively moving the logs and trees along the feed table to the feed roller; and
a second feed conveyor chain less than half the width of the feed roller, the second feed conveyor chain being trained around the second powered drive member and the second idler member for selectively moving the logs and trees along the feed table to the feed roller.
